(19) United States
(12) Patent Application Publication
(10) Pub. No.: US 2022/0388925 A1
(43) Pub. Date: Dec. 8, 2022

(54) PLANT STRENGTHENER BASED ON VESICULAR-ARBUSCULAR MYCORRHIZAE, EXTRACTS AND PLANT NUTRIENTS

(71) Applicant: BIOKRONE S.A. DE C.V., GTO (MX)

(72) Inventors: Francisco Javier VICENTE MAGUEYAL, CELAYA, GTO (MX); Jose Luis VELASCO SILVA, CELAYA, GTO (MX); Victor Alfonso SAENZ ALVARO, CELAYA, GTO (MX)

(21) Appl. No.: 17/642,847

(22) PCT Filed: Jul. 3, 2020
(86) PCT No.: PCT/MX2020/050014

§ 371 Date: Mar. 14, 2022

(30) Foreign Application Priority Data
Sep. 12, 2019 (MX) MX/A/2019/012107

(51) Int. Cl. C05F 11/08; C05G 5/12

(52) U.S. Cl. CPC C05F 11/08; C05G 5/12

(57) ABSTRACT

Biological plant strengthener (bio-strengthener) formulated as a wettable powder based on vesicular-arbuscular mycorrhizae and plant nutrients to improve crop yield. The formulation of the biological strengthener is designed with a consortium of spores belonging to vesicular-arbuscular mycorrhizal fungi strains Glomus geosporum, Gigaespora margarita, Glomus fasciculatum, Glomus constrictum, Glomus tortuosum, and Glomus intraradices.

### FIELD OF THE INVENTION

The present invention belongs to the area of Agricultural Biotechnology and refers to a plant biological strengthener (biostrengthener) formulated as a wettable powder from arbuscular vesicle mycorrhizae and plant nutrients to improve crop yields. The formulation of the biological strengthener is designed with a consortium of spores belonging to the arbuscular vesicle mycorrhizal fungal strains (Glomus geosporum, Gigaespora margarita, Glomus fasciculatum, Glomus constrictum, Glomus tortuosum, and Glomus intraradices), in addition the formulation is composed of acid extracts humic and fulvic, yucca extract (Yucca schidigera), seaweed extract (Ascophyllum nodosum) and natural rooters (2,4-D-indoleacetic acid). The product improves the efficiency of phosphorus (P), potassium (K), zinc (Zn), and copper (Cu) assimilation and increases plant resistance under stress conditions due to drought, salinity, frost, excessive rainfall, providing greater tolerance to diseases caused by nematodes and phytopathogenic fungi such as Phytophthora sp., Rizhoctonia sp., Pythium sp., Fusarium sp., among others. Furthermore, the present invention is formulated with elements that allow it to prolong its shelf life, effectiveness, and easy application alone or in mixture: oligosaccharides (maltodextrin, maltose, dextrin, dextrose), polysaccharides (starch, glycogen, cellulose, chitin, paramylon, agarose, peptidoglycans, proteoglycans, hyaluronic acid, amylose, fructan, keratin sulfate, dermatan sulfate, xylan, amylopectin), silicon dioxide, or hydrated aluminum silicate. The present invention comprises the formulation of a plant biostrengthener as a wettable powder to improve the efficiency in the assimilation of phosphorus (P), potassium (K), zinc (Zn), copper (Cu) and increase plant resistance under conditions of stress due to drought, salinity, frost, excess rainfall and provide greater tolerance to diseases caused by root pathogens such as nematodes and phytopathogenic fungi. Furthermore, it increases root volume for water and nutrient absorption, as well as providing hormones that stimulate plant growth thanks to the arbuscular vesicle mycorrhizae.

### OBJECT OF THE INVENTION

As a primary object, the inventive protection of the formulation of a plant biostrengthener comprising a wettable powder specifically designed to improve efficiency in the different fertilization systems (DRENCH, Pivots, drip, or band spray), efficiency in the assimilation of phosphorus (P), potassium (K), zinc (Zn), copper (Cu), increasing resistance to plants under stress conditions due to drought, salinity, frost, excess rainfall, and providing greater tolerance to diseases caused by pathogens root organisms such as nematodes and phytopathogenic fungi (Phytophthora sp., Rizhoctonia sp., Pythium sp., Fusarium sp. among others) are expected. Furthermore, it is expected to increase the volume of root action for the absorption of water and nutrients, as well as providing hormones that stimulate plant growth thanks to the arbuscular vesicle mycorrhizae. The formulation is made up of 1) 6 strains of vesicular arbuscular mycorrhizal fungi (VAM): Glomus geosporum, Gigaespora margarita, Glomus fasciculatum, Glomus constrictum, Glomus tortuosum and Glomus intraradices, 2) extracts of humic and fulvic acids, yucca extract (Yucca schidigera), seaweed extract (Ascophyllum nodosum) and natural rooting agents (2,4-D-indoleacetic acid) and 3) elements of the formulation that allow it to prolong its shelf life, effectiveness, and ease of application in which elements alone or in mixture are comprised: oligosaccharides (maltodextrin, maltose, dextrin, dextrose), polysaccharides (starch, glycogen, cellulose, chitin, paramylon, agarose, peptidoglycans, proteoglycans, hyaluronic acid, amylose, fructan, keratin sulfate, dermatan sulfate, xylan, amylopectin), silicon dioxide, or hydrated aluminum silicate.

### Background Art

According to World Bank projections, the population is expected to reach seven billion people by 2020. These people will need clothing, housing, and certainly food. The production and quality assurance of crops is of great economic interest since it will continue to be the main source of food globally. One of the most widely used strategies for decades is traditional fertilization based on chemical molecules (urea, nitrates, phosphates, etc.) with the aim of increasing the availability of essential elements to promote plant growth and increase production, however, their excessive use can cause irreparable damage to the soil, groundwater, the atmosphere, human health, and the ecosystem. A friendly alternative to the environment to ensure food is through rational exploitation of our resources through the use of systems and technologies with low environmental impact. Some existing technologies have managed to open the way to a responsibility in agriculture, however, it is necessary to consider within the development of functional products: 1) cost, 2) its effectiveness, and 3) the benefit for optimal performance. Getting to the point, emphasis can be made on the following: 1) the cost of conventional fertilizers in recent decades has multiplied its price up to eight times, hence the price of food in the chain of primary products and services has increased production and impacted population economy; 2) the reported efficiency of conventional fertilizers is only 20 to 30%, that is to say, more than 50% of the total volume of fertilizers is not used by the crop, causing accumulation in the soil, erosion, contamination of water tables and, as a result, subsequent damage to the biota close to the area and to human beings. The use of biofertilizers helps in a preventive and corrective way; 3) the use of microbial-based fertilizers, plant extracts, and the incorporation of plant nutrients improve soil quality, increase the availability of nutrients, and prevent different types of diseases, avoiding accumulation and therefore toxicity to the plant or soil.

Mycorrhiza (from the Greek myces, fungus and rhiza, root) is a representation of the association of mycorrhizal fungi and plant roots. The term mycorrhiza was first described in 1877 by forest pathologist Frank when studying the roots of some forest trees. When mycorrhizae come into contact with the root exudates of the plants, they respond by penetrating the roots to the plant cells, forming a beneficial association for the plant and the fungus by supplying it with nutrients that the plant cannot absorb. Mycorrhizae are fundamentally important in some resource-limited ecosystems, without them growth and thus yield may be reduced. Currently, a series of inventions segregated in different areas and separately using genera and species of mycorrhizae, plant extracts, and essential nutrients can be found in the literature. However, there is no invention entailing a synergy between these for the elaboration of a highly effective technology.

The object of the present invention is the inventive protection of a biological strengthener designed to improve the efficiency in phosphorus assimilation (P), increase the resistance of plants under stress conditions due to drought, salinity, frost, excessive rainfall, and provide a greater tolerance to diseases caused by root pathogens such as nematodes and phytopathogenic fungi (Phytophthora sp., Rizhoctonia sp., Pythium sp., Fusarium sp., among others).

Some efforts have been made for the establishment within the development of biofortifying technologies, however, few have been taken to the field of industrial activity. Mention is made of those technologies relevant to the present invention.

Spanish patent ES 2397298T3 refers to liquid mycorrhizal compositions and methods for colonizing a plant, herb, branch, or shrub with one or more mycorrhizae. Specifically, it relates to compositions that enhance the ability of mycorrhizae to colonize plant roots, resulting in superior efficacy of plant treatment formulations containing the mycorrhizae.

Spanish patent ES2159258B1 mentions the procedure for preparing a biofertilizer based on fungi that form arbuscular mycorrhizal symbiosis. The invention consists of a method of preparing a biofertilizer obtained with the homogeneous mixture of a carrier substrate of arbuscular mycorrhizal fungal propagative material together with previously detoxified paper, and its subsequent compaction. In this way, a granulated biofertilizer made up of low-cost constituents is obtained, applicable not only to greenhouse or nursery crops, but also on a large scale.

Mexican patent MX/2014/012524 (WO2013/158900A1) comprises a combination of a phytate and a variety of microorganisms that include the fungus Trichoderma virens, Bacillus amyloliquefaciens and also one or a mixture of mycorrhizal fungi that are placed in the rhizosphere of the plant allowing them to colonize said vegetable root as well as a method for increasing plant yield comprising: placing a combination of a phytate and a plurality of microorganisms comprising a Trichoderma virens fungus, a Bacillus amyloliquefaciens bacterium, and one or a mixture of mycorrhizal fungi in the rhizosphere of the plant way that allows microorganisms to colonize said plant root.

Spanish patent ES2190286T3 comprises a fertilizer for higher plants, existing in granular form, which contains at least 50 percent of weight of malt germs, which are produced in cereal malting for beer brewing and separated of the malt grain, wherein the fertilizer is preferably and essentially constituted by this type of malt germs, characterized in that each ton of grains contains at least 10 g of mycorrhizal spores, preferably at least 25 g of mycorrhizal spores and/or at least 5 weight percent mycelia, preferably at least 15 weight percent mycelia of at least one species of mycorrhizal fungus.

Document C04600641 A1 describes a liquid biological fertilizer consisting of fungi of plant origin, which is non-pathogenic for humans, of the mycorrhizal genus capable of absorbing poorly mobile nutrients from the soil such as phosphorus, sulfur, potassium, zinc, resulting in the growth of the root of the plants and consequently improving the characteristics of productivity and vigor of all types of plants.

Document AR100735 refers to a method for improving the growth, development and productivity of non-legume plants by implementing a composition comprising at least one mycorrhiza and at least one yeast extract, and optionally a substrate. The present application also relates to such a composition, and, when a substrate is comprised, to a process for its preparation.

Document ES2201661 refers to methods and compositions for improving the quality of grass in a lawn by using VA mycorrhiza as a growth retardant for Poa annus. More specifically, the invention relates to the control, reduction or elimination of undesirable weeds in a lawn, especially a high-quality lawn consisting primarily of grassy weeds, such as Agrostis stolonifera or Fescue species.

Document ES2659385 describes the use of a fertilizer that affects the distribution of plant biomass. More specifically, the fertilizer can stimulate root growth, fine root development, and increase the number of root tips and mycorrhizal development. Furthermore, the invention provides a method of using the fertilizer for the modulation of the biomass root fraction.

Therefore, there is still a need for a strengthener that contains a mixture of arbuscular vesicle mycorrhizae, plant nutrients and plant extracts that have the ability to stimulate plant growth, increase root volume, and provide better efficiency in phosphorus assimilation and other nutrients, in addition to providing resistance to plants under stress conditions due to drought, salinity, frost, excessive rainfall, and greater tolerance to diseases.

### BRIEF DESCRIPTION OF DRAWINGS

For a better understanding the invention and as its advantages, a detailed description of the same is provided with the support of the included FIGURES, which only illustrate the preferred embodiments of the invention and should therefore not be considered as limiting.

FIG. 1a shows the staining of the wheat root where the arbuscular vesicle mycorrhizal spore from the biofortifying formulation is synergistically adhered to the surface.

FIG. 1b shows the beneficial effect on wheat root elongation and root density by using the plant biostrengthener at 15 days of germination. Treatments containing the plant biostrengthener are shown on the right side and control treatment on the left.

FIG. 1c shows the beneficial effect on wheat root elongation and root density by using the plant biostrengthener at 30 days of germination. Treatments containing the plant biostrengthener are shown on the left side and control treatment on the right.

FIG. 1d shows spores of the arbuscular vesicle mycorrhizae belonging to the plant biostrengthener. Spores were isolated from the mixture for observation.

FIG. 1e shows the density of the root biomass mentioned in example 3.

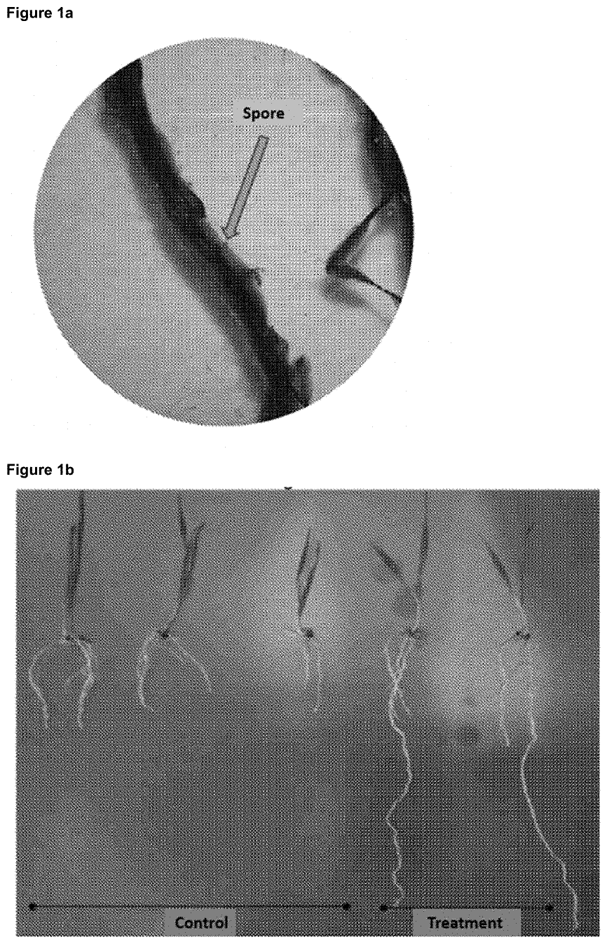

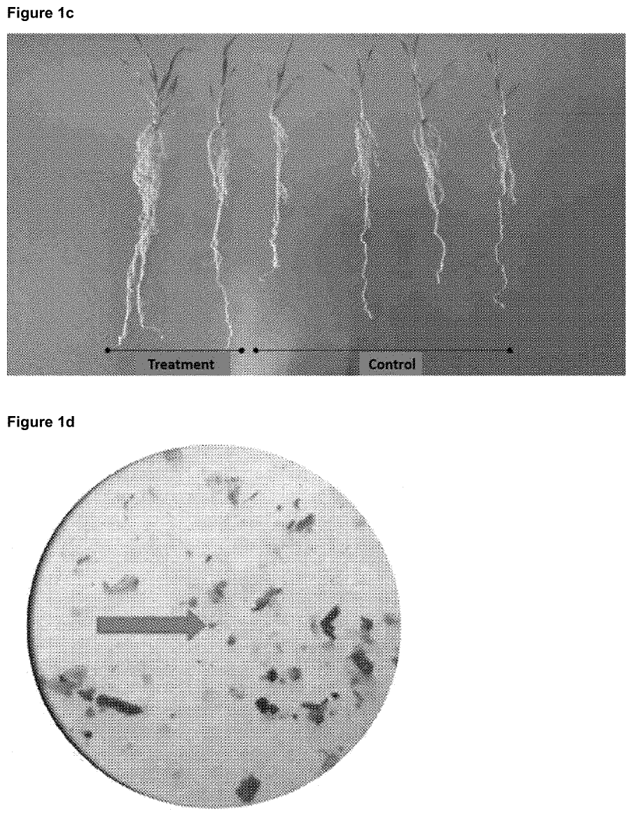

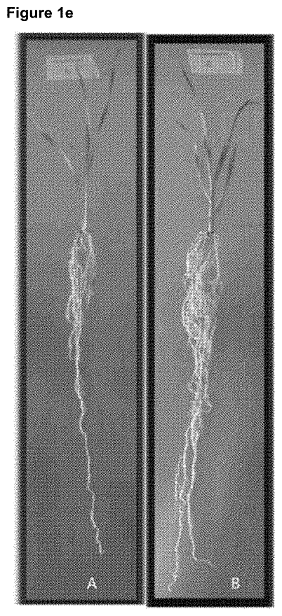

### BRIEF DESCRIPTION OF THE PROBLEM

The indiscriminate application of synthetic chemical products to increase crop productivity has caused a progressive deterioration of the current ecosystem. Most synthetic chemical fertilizers are applied in large quantities; however, these are assimilated in small concentrations by plants, causing leaching, fixation, and erosion of the remaining material in the subsoil. It is necessary to search for new technologies that allow a balance between production cost-performance and that are friendly to the surrounding ecosystem. An alternative that aims to solve this problem is the use of biorational technologies where endemic microorganisms take place. Mycorrhizae provide the plant through a beneficial symbiosis of nutrients (water, macro, and microelements) that the plant is unable to assimilate optimally. However, there is some uncertainty of new technologies where the selected mycorrhiza is not adapted to crops with greater economic activity, pests and different environmental conditions. Moreover, a mixture of different plant compounds that fortify and potentiate the mycorrhizal-plant symbiont activity has not been considered.

The need for good fertilization conditions is the most important and critical factor for optimal performance. The objective of fertilization is to bring the necessary elements to nourish the plant, however, there are problems with traditional granular fertilizers added in irrigation, drench and pivot systems in which precipitation occurs if the solubility of the fertilizer or product is exceeded, the precipitate is deposited on the walls of the tubes, in the holes of drippers and sprinklers, completely clogging the system. The present invention belongs to the area of Agricultural Biotechnology and refers to a biological strengthener as a wettable powder from vesicular arbuscular mycorrhizae (VAM) and plant nutrients to improve crop yields. The formulation of the biological strengthener is designed with a consortium of spores belonging to the vesicular arbuscular mycorrhizal fungi (VAM) strains: Glomus geosporum, Gigaespora margarita, Glomus fasciculatum, Glomus constrictum, Glomus tortuosum and Glomus intraradices, in addition the formulation is composed of humic and fulvic acid extracts, cassava extract (Yucca schidigera), seaweed extract (Ascophyllum nodosum) and natural rooters (indoleacetic acid). The product improves the efficiency in the assimilation of phosphorus (P), potassium (K), zinc (Zn), copper (Cu) and increases plant resistance under stress conditions due to drought, salinity, frost, and excessive rainfall. It also has a particle size that prevents sedimentation, segregation, and deposit in conventional fertilization systems and provides greater tolerance to diseases caused by Phytophthora sp., Rizhoctonia sp., Pythium sp., Fusarium sp., among others.

### DETAILED DESCRIPTION OF THE INVENTION

The present invention belongs to the area of Agricultural Biotechnology and refers to a plant strengthener as a wettable powder with a particle size that allows optimal assimilation of crops, protection from the root and blockage by sedimentation of nozzles and conventional systems of fertilization.

An effective composition of a biological strengthener is described as a wettable powder to increase yields thanks to its formulation. The present invention is described from the following 4 scenarios: 1) Biological composition as microbial active ingredient, 2) Active ingredients as nutrients and plant growth enhancers, 3) Inert compounds in the formulation, and 4) Final particle size.

1) Biological Composition as a Microbial Active Ingredient.

The formulation of the biological strengthener is designed with a consortium of spores alone or in mixture belonging to the vesicular arbuscular mycorrhizal fungi (VAM) strains: Glomus geosporum, Gigaespora margarita, Glomus fasciculatum, Glomus constrictum, Glomus torluosum and Glomus intraradices which is supplied in the formulation in a percentage of 0.1-50% (w/w) (containing a concentration of 25-110 propagules/g) as a biological active ingredient.

2) Active Ingredients as Nutrients and Plant Growth Enhancers.

A formulation for the biological composition comprising extracts of humic and fulvic acids in a concentration of 0.1% to 25%, yucca extract (Yucca schidigera) in a concentration of 0.01% to 10%, seaweed extract (Ascophyllum nodosum) in a concentration of 0.01 to 10% and natural rooting agents (2,4-D-indoleacetic acid) that ensure a concentration of 0.001 to 1%.

3) Inert Compounds in the Formulation.

In order for the inoculant to provide effectiveness and long shelf life, it is necessary to apply it in the form of a single composition by formulating it with inert compounds alone or in a mixture of: oligosaccharides (maltodextrin, maltose, dextrin, dextrose) ensuring a concentration of at least 45%%, polysaccharides (starch, glycogen, cellulose, chitin, paramylon, agarose, peptidoglycans, proteoglycans, hyaluronic acid, amylose, fructan, keratin sulfate, dermatan sulfate, xylan, amylopectin) ensuring a concentration of at least 0.1%-3% and a silicon source (Mg₃Si₄O₁₀(OH)₂, CaSi, H₄SiO₄, AlSi₃, CaAl₂Si₂O₈, 2NaAlSi₃O₈, SiO₂, 4H₄SiO₄) ensuring a concentration of at least 0.1% to 0.5%. Everything must add up to a concentration between 40 to 47%.

4) Final Particle Size.

The final formulation should contain a particle size between 177 microns and 105 microns at a pH of 8-10 for optimal performance.

The mixture of 1) Biological composition of the arbuscular vesicle mycorrhizae, 2) Active ingredients as nutrients and plant growth enhancers and 3) Inert compounds in the formulation, where everything must add up to 100%.

The mixture of the elements that make up the plant strengthener being the subject matter of the present invention can be mixed in accordance with the following order:

a) Weighing each of the nutrients that comprise the biological composition.

b) Weighing and adding the consortium of mycorrhizal spores according to the mesh and adding them to the mixer.

c) Adding the humic and fulvic acids to the mixer.

d) Adding the algae and yucca extract to the mixer.

e) Mixing until the composition is homogeneous.

f) Weighing and adding the inert compounds to the mixer.

g) Time varies according to the volume produced; however, 15-30 min are usually adequate at a mixing speed of 80-150 rpm.

h) Unloading the massive production that corresponds to the vegetable strengthener in containers.

i) Storage in containers labeled for storage.

### EXAMPLES

The following examples are intended to illustrate the invention, not to limit it. Any variation by those skilled in the art falls within the scope thereof.

### Example 1

The following example demonstrates the biological activity of the biostrengthener from vesicular arbuscular mycorrhizae (VAM) and plant nutrients to improve crop yield. More specifically, the action of the biological strengthener is demonstrated as an inoculant in tomato crop (Solanum lycopersicum) belonging to the Solanaceae family.

Testing crop: Tomato var. Serengeti.

Phenological state of the plant: In vegetative development, flowering and harvest of tomato crop.

Soil type: clay.

Experimental design: Random blocks with four repetitions. The experimental unit of 2 furrows of 1.0 m wide by 60 m long, which makes an experimental area of 1,200 m². An analysis of variance and a mean separation test were performed with the Tukey test at 95% reliability. Three doses of the biological strengthener in question were evaluated, a regional control and an absolute control (Table 1).

TABLE 1
Treatments and doses evaluated to determine the biological effectiveness
of the biostrengthener in tomato (Solanum lycopersicum).

| | | Dosage kg/ha | Dosage kg/ha |
|---|---|---|---|
| Treatment | Product | (at transplant) | (flowering) |
| T1 | Biological fortifier | 1.0 | 1.0 |
| T2 | Biological fortifier | 1.5 | 1.5 |
| T3 | Biological fortifier | 2.0 | 2.0 |
| T4 | Regional control | 1.0 | 1.0 |
| T5 | Absolute control | 0 | 0 |

Each treatment was applied twice to the soil in drip irrigation, in doses of 1.0, 1.5, and 2.0 kg for application in transplanting and flowering, for the surface to be treated according to the experimental design. Two applications were made to the soil in drip irrigation, in transplantation and flowering, on the experimental units destined for each treatment.

Biological Effectiveness Estimation Variables:

a) Periodic growth: Plant height was estimated at 15, 30, 45, and 60 days after the first application. Measurement was made on 10 random plants in each experimental unit (complete rows).

b) Stem thickness. Stem thickness at ground level was determined 45 days after transplantation in 10 random plants per experimental unit, in 10 plants per experimental unit.

c) Distance from the head to the flowering bouquet. It was evaluated 45 days after transplantation, in 10 plants per experimental unit.

d) Distance between the complete fertilized bunch and the flowering bunch. It was evaluated 60 days after transplantation, in 10 plants per experimental unit.

e) Leaf length. Leaf length in full development was evaluated in the middle part of the plant at 45 days after transplantation, in 10 leaves per experimental unit.

f) Root length. It was evaluated 90 days after transplantation, in 5 plants per experimental unit.

g) Number of compound leaves per plant. The leaf number per plant was counted in 5 plants per experimental unit 45 days after transplantation.

h) Weight yield of fruits/5 plants. In each weekly cut, the fruits of 5 previously labeled plants were weighed, for the final stage of crop production it was determined in kg/plant, extrapolating to yield per hectare according to the density of plants/ha.

i) Phytotoxicity. In order to evaluate if the product exerts some type of phytotoxic effect on the corn crop, any abnormal symptomatology of the plants, flowers, and fruits was evaluated with respect to those observed in the absolute control, using the values of the EWRS scale. (Table 2).

j) Fruit size. Sampling of 100 fruits per experimental unit was carried out and fruits were separated according to fruit number of 1st, 2nd and 3rd quality in order to determine their percentage.

k) Fruit coloration. Color uniformity was evaluated from a sample of 100 fruits, selecting those at commercial maturity. Those that presented a uniform color and appearance were separated, determining their percentage.

l) Brix degrees. With the use of the refractometer, Brix degrees per fruit were determined in a sample consisting of 5 fruits per experimental unit.

TABLE 2
EWRS scoring scale to evaluate the phytotoxic effect
on tomato crops (Solanum lycopersicum).

| Score | intolerance symptoms |
|---|---|
| 1 | No effect |
| 2 | Very mild symptoms |
| 3 | Mild symptoms |
| 4 | Symptoms not reflected in performance |
| 5 | Medium damage |
| 6 | High damage |
| 7 | Very high damage |
| 8 | Severe damage |
| 9 | Death |

Statistical Analysis to Verify Significance Between Treatments.

An analysis of variance and a mean separation test with Tukey's test (alpha of 0.05) were applied to the variables evaluated using the SAS statistical package. Results were analyzed and discussed based on the statistical difference and what was observed in the field.

Results

A. Periodic Growth

First evaluation: 15 days. It was possible to observe 4 statistical groupings (A, AB, B, and C) after 15 days of cultivation. The T3 treatment (2.0 kg/ha) showed a higher mean with 44.17 cm, while the absolute control showed a mean of 27.72 cm (Table 3).

TABLE 3
Treatments and doses evaluated to determine the biological
effectiveness of the biostrengthener at 15 days in
tomato crop (Solanum lycopersicum).

Growth at 15 days (cm)

| Treatment | Dose kg/ha | Mean | α* |
|---|---|---|---|
| T1 | 1.0 | 34.37 | B |
| T2 | 1.5 | 40.17 | AB |
| T3 | 2.0 | 44.17 | A |
| T4 | 1.0 | 40.27 | AB |
| T5 | 0 | 27.72 | C |

Second evaluation: 30 days. In the analysis of variance for plant growth in cm at 30 days (Table 4), it can be seen that there are significant effects in the treatments for differentiation with the absolute control, 4 groupings could be observed between the treatments (A, AB, BC and C). It is observed that T3 (2.0 kg/ha) shows the greatest height, with a mean of 78.62 cm and with a difference with T5 (0 kg/ha) that showed a mean of 67.87 cm.

TABLE 4
Treatments and doses evaluated to determine the
biological effectiveness of the strengthener at
30 days in tomato crop (Solanum lycopersicum).

Growth at 30 days (cm)

| Treatment | Dose kg/ha | Mean | α* |
|---|---|---|---|
| T1 | 1.0 | 72.07 | BC |
| T2 | 1.5 | 76.02 | AB |
| T3 | 2.0 | 78.62 | A |
| T4 | 1.0 | 75.62 | AB |
| T5 | 0 | 67.87 | C |

Third evaluation: 45 days. In the analysis of variance table for plant growth in cm at 45 days, 4 statistical groups can be observed (Table 5). The T3 treatment (2.0 kg/ha) shows the highest mean for height with 98.80 cm, while the absolute control T5 (0 kg/ha) shows a mean of 87.07 cm.

TABLE 5
Treatments and doses evaluated to determine the biological
effectiveness of the biostrengthener at 45 days in
tomato crop (Solanum lycopersicum).

Growth at 45 days (cm)

| Treatment | Dose kg/ha | Mean | α* |
|---|---|---|---|
| T1 | 1.0 | 93.15 | B |
| T2 | 1.5 | 95.72 | AB |
| T3 | 2.0 | 98.8 | A |
| T4 | 1.0 | 94.67 | B |
| T5 | 0 | 87.07 | C |

Fourth evaluation: 60 days. The analysis of variance for growth shows significant effects, forming 5 statistical groups (A, B, BC, C, and D), with T3 (2.0 kg/ha) having a mean of 140.90 cm and higher than the regional (1 kg/ha) and absolute control (0 kg/ha) (Table 6).

TABLE 6
Treatments and doses evaluated to determine the biological
effectiveness of the biostrengthener at 60 days in
tomato crop (Solanum lycopersicum).

Growth at 60 days (cm)

| Treatment | Dose kg/ha | Mean | α* |
|---|---|---|---|
| T1 | 1.0 | 130.35 | C |
| T2 | 1.5 | 135.15 | BC |
| T3 | 2.0 | 140.90 | A |
| T4 | 1.0 | 135.67 | B |
| T5 | 0 | 124.42 | D |

B. Stem Thickness.

Stem thickness measurements in cm are shown (Table 7), wherein significant differences between the treatments can be observed. Two statistical groups were formed (A and B). Group A formed by the high dose T3 (2.0 kg/ha) and medium T2 (1.5 kg/ha) and group B formed by the low dose T1 (1.0 kg/ha), the regional control, and the absolute control. The highest mean showed a thickness of 13.40 cm of T3 (2.0 kg/ha).

TABLE 7
Treatments and doses evaluated for stem thickness by the effect
of the biostrengthener in tomato crop (Solanum lycopersicum).

Stem thickness (cm)

| Treatment | Dose kg/ha | Mean | α* |
|---|---|---|---|
| T1 | 1.0 | 10.30 | B |
| T2 | 1.5 | 12.57 | A |
| T3 | 2.0 | 13.40 | A |
| T4 | 1.0 | 12.57 | A |
| T5 | 0 | 9.12 | B |

C. Distance from Head to Flowering Bouquet.

Distance from head to the flowering bouquet measurements are shown. 3 statistical groups can be observed (Table 8), group A formed by the treatments under T1 (1.0 kg/ha), medium T2 (1.5 kg/ha), and high T3 (2.0 kg/ha), group B by the regional control T4 and group C formed by the absolute control T5. The highest mean of 73.55 cm corresponds to T3 (2.0 kg/ha).

TABLE 8
Evaluation of the distance from head to flowering bouquet
in flowering, in the evaluation study of the effect of the
biostrengthener in tomato crop (Solanum lycopersicum).

Distance from head to
flowering bouquet (cm)

| Treatment | Dose kg/ha | Mean | α* |
|---|---|---|---|
| T1 | 1.0 | 66.3 | A |
| T2 | 1.5 | 72.7 | A |
| T3 | 2.0 | 73.55 | A |
| T4 | 1.0 | 60.1 | B |
| T5 | 0 | 57.7 | C |

D. Distance Between Complete Fertilized Bunch and Flowering Bunch.

In the analysis of variance for distance between complete fertilized bunch and flowering bunch, 3 statistically different groups were observed, group A made up of the medium dose (1.5 kg/ha) and high dose (2.0 kg/ha), group B made up of the low dose (1.0 kg/ha), and the regional control (1.0 kg/ha) and group C made up of the absolute control (0 kg/ha). The largest mean belongs to T3 with a size of 37.40 cm (Table 9).

TABLE 9
Evaluation of distance between complete fertilized bunch
and flowering bunch in the study of the effect of the biostrengthener
on tomato crop (Solanum lycopersicum).

Distance between complete
fertilized bunch and
flowering bunch (cm)

| Treatment | Dose kg/ha | Mean | α* |
|---|---|---|---|
| T1 | 1.0 | 32.42 | B |
| T2 | 1.5 | 35.27 | A |
| T3 | 2.0 | 37.40 | A |
| T4 | 1.0 | 31.22 | B |
| T5 | 0 | 24.80 | C |

E. Leaf Length

In table 10 of the analysis of variance for leaf length in cm, three statistical groups are observed (A, B, and C). The greatest length was observed in T3 (2.0 kg/ha) with a mean of 29.30 cm, the absolute control (0 kg/ha) showed a mean of 20.05 cm.

TABLE 10
Evaluation of leaf length in the study of the effect of the
biostrengthener in tomato crop (Solanum lycopersicum).

Leaf length (cm)

| Treatment | Dose kg/ha | Mean | α* |
|---|---|---|---|
| T1 | 1.0 | 23.12 | B |
| T2 | 1.5 | 24.82 | B |
| T3 | 2.0 | 29.30 | A |
| T4 | 1.0 | 24.80 | B |
| T5 | 0 | 20.05 | C |

F. Root Length.

Significant differences in the treatments evaluated can be seen, forming 4 statistical groups (Table 11): group A formed by the high dose T3 (2.0 kg/ha) and having the greatest length with 27.90 cm; group AB formed by the medium dose T2 (1.5 kg/ha) and low dose T1 (1.0 kg/ha), group B formed by the regional control T4 (1.0 kg/ha), and group C formed by the absolute control T5 (0 kg/ha).

TABLE 11
Evaluation of root length in the study of the effect of the
biostrengthener in tomato (Solanum lycopersicum) crop.

Root length (cm)

| Treatment | Dose kg/ha | Mean | α* |
|---|---|---|---|
| T1 | 1.0 | 25.25 | AB |
| T2 | 1.5 | 25.45 | AB |
| T3 | 2.0 | 27.90 | A |
| T4 | 1.0 | 22.65 | B |
| T5 | 0 | 16.00 | C |

G. Number of Compound Leaves Per Plant.

4 statistical groups (A, AB, B, and C) were formed. Treatment T3 (2.0 kg/ha) showed the highest mean of 58.65 for the leaf number and the absolute control showed a mean of 39.40 leaves (Table 12).

TABLE 12
Evaluation of the number of compound leaves per plant,
in the study of the effect of the biostrengthener in
tomato crop (Solanum lycopersicum).

Compound leaves per plant (cm)

| Treatment | Dose g/ha | Mean | α* |
|---|---|---|---|
| T1 | 1.0 | 54.15 | AB |
| T2 | 1.5 | 54.55 | AB |
| T3 | 2.0 | 56.85 | A |
| T4 | 1.0 | 49.65 | B |
| T5 | 0 | 39.40 | C |

G. Yield Ton/Ha.

4 statistical groups were formed. Group A was formed by the high dose T3 (2.0 kg/ha) with the highest mean of 203.70 ton/ha, group AB was formed by the medium treatment T2 (1.5 kg/ha), group B was formed by the low dose T1 (1.0 Kg/ha), and the regional control (1.0 kg/ha) and group C were formed by the absolute control (0 kg/ha) with a mean of 139 ton/ha (Table 13).

TABLE 13
Evaluation of yield of fruits/5 plants, in the study of the effect
of the biostrengthener in tomato crop (Solanum lycopersicum)

Fruit yield/5 plants

| Treatment | Dose g/ha | Mean | α* |
|---|---|---|---|
| T1 | 1.0 | 189.95 | AB |
| T2 | 1.5 | 189.63 | AB |
| T3 | 2.0 | 203.70 | A |
| T4 | 1.0 | 179.95 | B |
| T5 | 0 | 139.45 | C |

I. Fruit Caliber.

4 statistical groups were formed in the analysis of variance corresponding to the evaluation of fruit caliber: group A formed by T3 (2.0 kg/ha), group AB formed by T2 (1.5 kg/ha), and group A regional control, group B formed by T1 (1.0 kg/ha) and group C formed by the absolute control. T3 showed the highest mean with a value of 95.4% of first quality fruits (Table 14).

TABLE 14
Evaluation of the size of fruits in the study of the effect of
the biostrengthener in tomato crop (Solanum lycopersicum).

Fruit caliber (%)

| Treatment | Dose g/ha | Mean | α* |
|---|---|---|---|
| T1 | 1.0 | 90.30 | B |
| T2 | 1.5 | 92.85 | AB |
| T3 | 2.0 | 95.40 | A |
| T4 | 1.0 | 92.10 | AB |
| T5 | 0 | 80.85 | C |

J. Degrees Brix.

2 statistical groups were formed in the analysis of variance corresponding to the evaluation of degrees brix: group A formed by T2 (1.5 kg/ha), the regional control, and T1 (1.0 kg/ha), and group B formed by the absolute control. T3 showed the highest mean with a value of 5.2° Bx (Table 15) while the control mean was 4.02° Bx (Table 15).

TABLE 15
Evaluation of degrees brix in the study of the effect of the
biostrengthener in tomato crop (Solanum lycopersicum).

°Brix

| Treatment | Dose g/ha | Mean | α* |
|---|---|---|---|
| T1 | 1.0 | 4.70 | A |
| T2 | 1.5 | 5.07 | A |
| T3 | 2.0 | 5.10 | A |
| T4 | 1.0 | 5.00 | A |
| T5 | 0 | 4.02 | B |

### Conclusions

1. The doses of 1.0, 1.5, and 2.0 kg/ha of the biostrengthener were effective in increasing the yield of tomato crop (Solanum lycopersicum) due to the fact that when used, it is possible to obtain a greater number of fruits per plant and a higher quality of these fruits and consequently an increase of 30%.

2. The best variables to differentiate the effect of the biostrengthener at the doses presented were: plant height, stem thickness, yield (ton/ha), fruit size, and fruit color.

3. There were no toxic effects on tomato crop due to the application of the doses mentioned.

### Example 2

A nutritional comparison was carried out in tomato (Solanum lycopersicum) using the best dose obtained in example 1 (T3, 2.0 kg/ha), the regional control (T4, 1.0 kg/ha), and the absolute control (T5, 0 kg/ha). An analysis of total nitrogen content (Kjendhal AOAC method, 1995), phosphorus, potassium, calcium, magnesium, manganese, zinc, and sulfur in fruit and plant (Karla, 1998; Temminghoff & Houba, 2004) was carried out from lyophilized tissue and without including seeds in the case of fruits (Table 16).
AOAC. 1995. 16th ed. Arlington, UA, 684 pp.
Karla, Y. P. 1998. Handbook of reference methods for plant analysis. Soil and plant Analysis Council. Inc. CRC Press, USA: 300 pp.
Temminghoff, J. M. & Houba, V. J. G. 2004. Plant analysis procedures. Second edition. Kluwer Academic Publishers, 179.

Results

Nutrient Analysis of the Fruit.

Significant differences and statistical groups were observed for each of the nutrients evaluated for the nutritional analysis parameter of the fruit (Table 16).

For nitrogen (N): There were significant differences between the treatments with application and the absolute control, treatment T3 (2.0 kg/ha) showed a higher mean with 4.07% concentration of this element.

Phosphorus: There is a significant difference between the treatments with application and the absolute control, the highest mean obtained was from the T3 treatment (2.0 g/ha) with 0.51%.

Potassium: There is a significant difference between the treatments with application and the absolute control, the highest mean obtained was from the T3 treatment (2.0 kg/ha) with 3.35%.

Calcium (Ca): There is a significant difference between the treatments with application and the absolute control, the highest mean obtained was from the T3 treatment (2.00 kg/ha) with 0.2%.

Magnesium (Mg): There is a significant difference between the treatments with application and the absolute control, the highest mean obtained was from treatment T3 (2.0 kg/ha) with 0.3%

Manganese (Mn): There is a significant difference between the treatments with application and the absolute control, the highest mean obtained was from the T3 treatment (2. kg/ha) with 60 ppm.

Zinc (Zn): There is a significant difference between the treatments with application and the absolute control, the highest mean obtained was from the T3 treatment (2.0 kg/ha) with 0.39 ppm.

Sulfur (S): There is a significant difference between the treatments with application and the absolute control, the highest mean obtained was from the T3 treatment (2.0 kg/ha) with 214.7 ppm.

The fruit with the highest concentration of nutrients was found in the T3 treatment (2.0 kg/ha).

TABLE 16
Evaluation of fruit nutritional analysis, in the evaluation study of the
effect of the biostrengthener in tomato crop (Solanum lycopersicum).

| | N | | P | | K | | Ca | | Mg | | Mn | | Zn | | S | |
|---|---|---|---|---|---|---|---|---|---|---|---|---|---|---|---|---|
| | X | G | X | G | X | G | X | G | X | G | X | G | X | G | X | G |
| T3 | 4.07 | A | 0.51 | A | 3.35 | A | 0.2 | A | 0.3 | A | 60.0 | A | 0.39 | A | 214.7 | A |
| T4 | 3.40 | B | 0.37 | B | 2.85 | B | 0.19 | A | 0.25 | B | 55.2 | A | 0.30 | B | 207.5 | B |
| T5 | 3.10 | B | 0.26 | C | 2.05 | C | 0.11 | B | 0.13 | C | 30.0 | B | 0.16 | C | 134.0 | C |

X: Mean
G: Group (α*)

Plant Nutritional Analysis.

Significant differences and statistical groups were observed for each of the nutrients evaluated for the plant nutritional analysis parameter (Table 17).

For nitrogen (N): There is a significant difference between the treatments with application and the absolute control, the highest mean was that of the T3 treatment (2.0 kg/ha) with 4.90% concentration.

Phosphorus: There is a significant difference between the treatments with application and the absolute control, the highest mean obtained was from the T3 treatment (2.0 kg/ha) with 0.91%.

Potassium: There is a significant difference between the treatments with application and the absolute control, the highest mean obtained was from the T3 treatment (2.0 kg/ha) with 5.62%.

Calcium (Ca): There is a significant difference between the treatments with application and the absolute control, the highest mean obtained was from the T3 treatment (2.0 kg/ha) with 4.35%.

Magnesium (Mg): There is a significant difference between the treatments with application and the absolute control, the highest mean obtained was from the T3 treatment (200 g/ha) with 0.4%.

Manganese (Mn): There is a significant difference between the treatments with application and the absolute control, the highest mean obtained was from treatment T3 (2.0 kg/ha) with 0.92%.

Zinc (Zn): There is a significant difference between the treatments with application and the absolute control, the highest mean obtained was from the T3 treatment (2.0 kg/ha) with 86.5 ppm.

Sulfur (S): There is a significant difference between the treatments with application and the absolute control, the highest mean obtained was from the T3 treatment (2.0 kg/ha) with 898 ppm.

The plant with the highest concentration of nutrients was found in the T3 treatment (2.0 kg/ha).

TABLE 17
Evaluation of plant nutritional analysis, in the evaluation study of the
effect of the biostrengthener in tomato crop (Solanum lycopersicum).

| | N | | P | | K | | Ca | | Mg | | Mn | | Zn | | S | |
|---|---|---|---|---|---|---|---|---|---|---|---|---|---|---|---|---|
| | X | G | X | G | X | G | X | G | X | G | X | G | X | G | X | G |
| T3 | 4.90 | A | 0.91 | A | 5.62 | A | 4.35 | A | 0.92 | A | 190 | A | 86.5 | A | 898 | A |
| T4 | 4.37 | A | 0.79 | B | 4.87 | A | 3.82 | B | 0.82 | A | 177 | B | 85.5 | A | 862 | A |
| T5 | 2.10 | B | 0.41 | C | 3.35 | B | 1.97 | C | 0.43 | B | 86 | C | 43.50 | B | 589 | B |

X: Mean
G: Group (α*)

Conclusion: In plants, T3 (2.0 kg/ha) was found to have the best attributes in terms of nutrients.

### Example 3

A test of the effectiveness of the biostrengthener was carried out, wherein a better elongation and greater root volume were verified through mycorrhization in wheat root. A dose of 1.5 kg/ha was applied for the recommended volume of wheat seed. The experimental strategy consisted first of a disinfection process using a 5% sodium hypochlorite solution. Seed germination was carried out in a humid chamber at a temperature of 30° C. and a humidity of 48% after 4 days. Germinated seeds (95%) were then transferred to pots containing mineral substrate. After 15 and 30 days of germination, root staining was carried out according to the method proposed by Phillips and Hayman (1970). The amount of mycorrhizal spores present in the root of the plant could be observed, having greater volume and elongation of the root with respect to the control without treatment. There were 15 replicates for each treatment (Table 18).

TABLE 18
Evaluation of the leaf number, root biomass, and presence
of mycorrhizal spores in wheat (Triticum sp.)

| | Treatment (Control) | Treatment (1.0 kg/ha) |
|---|---|---|
| Indicator | Remarks | Remarks |
| Number of | Growth of 3 leaves on the plant 30 | Development of 5 leaves at 30 days after |
| leaves | days after sowing. | sowing. |
| Root | It showed small growth of secondary | Root development was greater than the |
| biomass | roots and root hairs. The average | control in terms of secondary roots and |
| | quantification of root biomass was | root hairs. The average quantification of |
| | 0.4 g ± 0.02. | root biomass was 0.9 g ± 0.05. |
| Number of | Between 20 and 25% mycorrhization | Through spore staining, between 60 and |
| spores | was found in each of the replicates | 65% mycorrhization in the repetitions of |
| | of the controls. | the treatment was observed. |

### Example 4

Evaluation study of the biological effectiveness of the inoculant and soil improver Glumix Irrigation, in tomato cultivation under Protected Agriculture conditions in Aguascalientes, Aguascalientes. The objective of the study was to evaluate the biological effectiveness of the biostrengthener in tomato (Solanum Lycopersicum var. Cid) under protected agriculture conditions, as well as the possible resulting phytotoxic effects.

Experimental Design

1. The experiment was established under a randomized complete block design, with four replications.

2. The experimental unit was made up of 3 beds 1.3 m wide equal to 3.9 m, by 3.0 m long, equivalent to 11.7 m2, giving a total of 46.8 m2 per treatment. A total area of 280.8 m2 was used.

3. During the sampling, one bed was removed from each end and 0.5 m from each end. The useful plot was 1 bed (3.5) by 4.0 m long, giving a total of 14 m2.

Distribution of Treatments

The distribution of field treatments after randomization was as follows.

TABLE 19
Distribution of field treatments.

| BLOCK I | BLOCK II | BLOCK III | BLOCK IV |
|---|---|---|---|
| T6 | T2 | T1 | T3 |
| T1 | T6 | T4 | T2 |
| T4 | T1 | T2 | T5 |
| T3 | T4 | T5 | T6 |
| T2 | T5 | T3 | T1 |
| T5 | T3 | T6 | T4 |

Dose, Moment and Number of Applications.

The treatments that were evaluated are indicated in Table 20.

TABLE 20
Treatments of the biostrengthener in tomato var. Cid. crop.

| | | Dose |
|---|---|---|
| Treatment | Product | Kg · ha⁻¹ |
| T1 | Absolute control | 0 |
| T2 | Biostrengthener | 1.0 |
| T3 | Biostrengthener | 2.0 |
| T4 | Biostrengthener | 2.5 |
| T5 | Biostrengthener | 3.0 |
| T6 | Biostrengthener | 3.5 |

Time and Number or Applications.

Two applications were carried out: the first occurred 5 days after transplantation. The application interval was 7 days between each one.

Forms of application: Drench.

Application equipment: Manual backpack sprayer.

Volume of water used: 50 ml per plant.

a) Other inputs used in the evaluation

No other type of input was used that interferes in the development of this study.

b) Biological effectiveness estimation variables and evaluation method.

Biological effectiveness measurement parameter: Two applications were made at the indicated stage, considering the following variables:

1. Phytotoxicity. It was evaluated 7 days after each application, using the percentage scale proposed by the European Weed Research Society (Table 2).

Phenological Stage

1. Plant height. It was measured with a tape measure on 3 random plants in the center of the experimental unit (repetition), 0 days before the first application and 7 days after the first and 14 days after the second application. The results were expressed as a numerical value.

2. Stem diameter: It was measured with a vernier in 3 random plants in the center of the experimental unit (repetition), 0 days before the first application and 7 days after the first and 14 days after the second application. The results were expressed in mm.

3. Leaf number: Leaf number of 3 plants randomly sampled in the center of the experimental unit (repetition), 14 days after the last application, was counted. The results were expressed as a numerical value.

4. Root fresh weight (g): It was determined in two randomly sampled plants per experimental unit (repetition). Roots were extracted, washed, and weighed by means of a digital scale with a capacity of 500 g at 14 days after the last application. The results were expressed in grams.

5. Root dry weight (g): It was determined in two randomly sampled plants per experimental unit (repetition) 14 days after the last application. Roots were dried in an oven in the laboratory, weighed by means of a digital scale with a capacity of 500 g. The results were expressed in g.

6. Fresh weight of the whole plant (g). It will be determined in 2 randomly sampled plants per experimental unit (repetition), which will be weighed by means of a digital scale with a capacity of 500 g 14 days after the last application. The results will be expressed in grams.

7. Dry weight of the whole plant (g). It was determined in 2 randomly sampled plants per experimental unit (repetition), which were weighed by means of a digital scale with a capacity of 500 g. The results were expressed in g.

8. Assimilation of Phosphorus, Potassium, and Zinc: A chemical analysis of the soil-plant was carried out to determine the assimilation of each of the compounds.

9. Chlorophyll content in leaves. Two leaves were taken from three plants per repetition, which was measured with the SPAD method. This method determines the relative amount of chlorophyll present through the measurement of the absorption of the leaves in two wavelength regions: red and near-infrared regions. Using these two transmissions, the measuring device calculates the SPAD numerical value that is proportional to the amount of chlorophyll present in the leaf and consequently of nitrogen, 14 days after the second application.

10. Stomatal conductance: Two leaves were taken on three plants per repetition, which were measured with a porometer.

Evaluation Method, which Must Allow a Statistical Analysis According to the Experimental Design and Evaluation Scale Used

Data Analysis. From the data obtained from the variables: plant height, stem diameter, leaf number, root fresh weight, root dry weight and whole plant fresh weight, plant dry weight, phosphorus assimilation, potassium, zinc and copper, chlorophyll content, and stomatal conductivity were statistically analyzed through an analysis of variance and Tukey's mean comparison test (a=0.05), using the SAS®9.0 statistical package.

Results and Discussion

Plant Height

An analysis of variance was carried out with the data of the variable height of the plant in tomato crop, which did not present significant differences between the treatments evaluated with respect to the absolute control. This was confirmed by a Tukey comparison of means (a=0.05) (Table 21).

TABLE 21
Comparison of means of the variable height of the plant

| Treatments | Dose | Plant height (cm) | Significance |
|---|---|---|---|
| T1 | — | 7.1 | A |
| T2 | 1.0 kg/ha | 7.2 | A |
| T3 | 2.0 kg/ha | 7.2 | A |
| T4 | 2.5 kg/ha | 7.1 | A |
| T5 | 3.0 kg/ha | 6.6 | A |
| T6 | 3.5 kg/ha | 6.7 | A |

1. Stem Diameter

When performing an analysis of variance with the data of the stem diameter variable in tomato crop, significant differences were observed between the treatments evaluated with respect to the absolute control. This was confirmed by a Tukey comparison of means (a=0.05) (Table 22).

TABLE 22
Comparison of means of the stem diameter variable

| | | Stem diameter | |
|---|---|---|---|
| Treatments | Dose | (mm) | Significance |
| T1 | — | 2.6 | A |
| T2 | 1.0 kg/ha | 2.7 | A |
| T3 | 2.0 kg/ha | 2.5 | A |
| T4 | 2.5 kg/ha | 2.4 | A |
| T5 | 3.0 kg/ha | 2.4 | A |
| T6 | 3.5 kg/ha | 2.5 | A |

Evaluation 1 (7 Days after First Application)

1. Plant Height

An analysis of variance was carried out with the data of the variable height of the plant in tomato crop, which did not show significant differences between the treatments evaluated with respect to the absolute control. This was confirmed by a Tukey comparison of means (a=0.05) (Table 23). However, a higher height was observed in numerical terms where the biostrengthener was applied.

TABLE 23
Comparison of means of the plant height variable

| Treatments | Dose | Plant height (cm) | Significance |
|---|---|---|---|
| T1 | — | 15.5 | A |
| T2 | 1.0 kg/ha | 18.1 | A |
| T3 | 2.0 kg/ha | 18.3 | A |
| T4 | 2.5 kg/ha | 16.9 | A |
| T5 | 3.0 kg/ha | 18.9 | A |
| T6 | 3.5 kg/ha | 18.7 | A |

2. Stem Diameter

When performing an analysis of variance with the data of the stem diameter variable in tomato crop, no significant differences were observed between the treatments evaluated with respect to the absolute control. This was confirmed by a Tukey comparison of means (a=0.05) (Table 24). However, a greater stem diameter was observed in numerical terms where the biostrengthener was applied.

TABLE 24
Comparison of means of the stem diameter variable

| | | Stem diameter | |
|---|---|---|---|
| Treatments | Dose | (mm) | Significance |
| T1 | — | 4.2 | A |
| T2 | 1.0 kg/ha | 4.9 | A |
| T3 | 2.0 kg/ha | 5.0 | A |
| T4 | 2.5 kg/ha | 4.9 | A |
| T5 | 3.0 kg/ha | 4.9 | A |
| T6 | 3.5 kg/ha | 5.0 | A |

Evaluation 2 (14 Days after Second Application)

1. Plant Height

The analysis of variance carried out with the data of the plant height variable in tomato crop showed significant differences between the treatments evaluated with respect to the absolute control. This was confirmed a Tukey comparison of means (a=0.05) (Table 10).

It was observed that the highest plant height was obtained with the biofortifying treatment at (2.0, 2.5, 3.0, and 3.5 kg/ha) allowing means of 40.8, 39.4, 41.6, and 38.8 centimeters. While the biostrengthener (1.0 kg/ha) showed a mean of 37.0 centimeters respectively (Table 25).

TABLE 25
Comparison of means of the variable height of the plant

| Treatments | Dose | Plant height (cm) | Significance |
|---|---|---|---|
| T1 | — | 31.9 | B |
| T2 | 1.0 kg/ha | 37.0 | AB |
| T3 | 2.0 kg/ha | 40.8 | A |
| T4 | 2.5 kg/ha | 39.4 | A |
| T5 | 3.0 kg/ha | 41.6 | A |
| T6 | 3.5 kg/ha | 38.8 | A |

2. Stem Diameter

An analysis of variance was carried out with the data of the stem diameter variable in tomato crop, showing significant differences between the treatments evaluated with respect to the absolute control. This was confirmed by a Tukey comparison of means (a=0.05) (Table 11). It was detected that the largest diameter of the stem was obtained with the biofortifying treatment at (2.0, 2.5, 3.0, and 3.5 kg/ha) allowing means of 15.4, 14.8, 15.5 and 15.4 millimeters. Furthermore, it was observed that the biostrengthener at (1.0 kg/ha) showed a mean of 13.7 millimeters, respectively (Table 26).

TABLE 26
Comparison of means of the stem diameter variable

| | | Stem diameter | |
|---|---|---|---|
| Treatments | Dose | (mm) | Significance |
| T1 | — | 12.0 | B |
| T2 | 1.0 kg/ha | 13.7 | AB |
| T3 | 2.0 kg/ha | 15.4 | A |
| T4 | 2.5 kg/ha | 14.8 | A |
| T5 | 3.0 kg/ha | 15.5 | A |
| T6 | 3.5 kg/ha | 15.4 | A |

3. Leaf Number

An analysis of variance was carried out with the data of the leaf number variable in tomato crop, without finding significant differences between the treatments evaluated with respect to the absolute control. This was confirmed by a Tukey comparison of means (a=0.05) (Table 27).

TABLE 27
Comparison of means of the leaf number variable

| Treatments | Dose | Leaf number | Significance |
|---|---|---|---|
| T1 | — | 10.0 | A |
| T2 | 1.0 kg/ha | 10.5 | A |
| T3 | 2.0 kg/ha | 10.8 | A |
| T4 | 2.5 kg/ha | 10.0 | A |
| T5 | 3.0 kg/ha | 11.3 | A |
| T6 | 3.5 kg/ha | 10.3 | A |

4. Root Fresh Weight

The analysis of variance carried out with the data of the fresh root weight variable in tomato crop showed significant differences between the treatments evaluated with respect to the absolute control. This was confirmed by a Tukey comparison of means (a=0.05) (Table 28). The highest root fresh weight was obtained with the biofortifying treatment (1.0, 2.0, and 3.5 kg/ha) since they allowed means of 13.2, 13.1, and 13.4 grams. These treatments were statistically equal to the biostrengthener (2.5 and 3.0 kg/ha) with means of 12.1 and 12.4 grams, respectively (Table 28).

TABLE 28
Comparison of means of the root fresh weight variable

| Treatments | Dose | Root fresh weight (g) | Significance |
|---|---|---|---|
| T1 | — | 8.2 | B |
| T2 | 1.0 kg/ha | 13.2 | A |
| T3 | 2.0 kg/ha | 13.1 | A |
| T4 | 2.5 kg/ha | 12.1 | AB |
| T5 | 3.0 kg/ha | 12.4 | AB |
| T6 | 3.5 kg/ha | 13.4 | A |

5. Root Dry Weight

An analysis of variance was carried out with the data of the root dry weight variable in tomato crop, showing significant differences between the treatments evaluated with respect to the absolute control. This was confirmed by a Tukey comparison of means (a=0.05). It was observed that the highest root dry weight was obtained with the biofortifying treatment (1.0, 2.0, 2.5, 3.0, and 3.5 kg/ha) since means of 6.8, 6.5, 7.0, 7.4, and 7.1 grams were obtained, respectively (Table 29).

TABLE 29
Comparison of means of the root dry weight variable

| Treatments | Dose | Root dry weight (g) | Significance |
|---|---|---|---|
| T1 | — | 13.4 | B |
| T2 | 1.0 kg/ha | 14.5 | AB |
| T3 | 2.0 kg/ha | 14.8 | AB |
| T4 | 2.5 kg/ha | 15.4 | AB |
| T5 | 3.0 kg/ha | 15.9 | A |
| T6 | 3.5 kg/ha | 15.7 | AB |

Whole Plant Fresh Weight

In the analysis of variance carried out with the data of the fresh weight variable of the whole plant in tomato crop, significant differences were obtained between the treatments evaluated with respect to the absolute control. This was confirmed by a Tukey comparison of means (a=0.05). Furthermore, the highest fresh weight of the entire plant was obtained with the biofortifying treatment (3.0 kg/ha) which allowed a mean of 15.9 grams. This treatment was statistically equal to the biostrengthener (1.0, 2.0, 2.5, and 3.5 kg/ha) with means of 14.5, 14.8, 15.4, and 15.7 grams, respectively (Table 30).

TABLE 30
Comparison of means of the whole plant fresh weight variable

| | | Whole plant fresh | |
|---|---|---|---|
| Treatments | Dose | weight (g) | Significance |
| T1 | — | 13.4 | B |
| T2 | 1.0 kg/ha | 14.5 | AB |
| T3 | 2.0 kg/ha | 14.8 | AB |
| T4 | 2.5 kg/ha | 15.4 | AB |
| T5 | 3.0 kg/ha | 15.9 | A |
| T6 | 3.5 kg/ha | 15.7 | AB |

6. Whole Plant Dry Weight

An analysis of variance was carried out with the data of the whole plant fresh weight variable in tomato crop, which showed significant differences between the treatments evaluated with respect to the absolute control. This was confirmed by performing a Tukey comparison of means (a=0.05). The highest dry weight of the entire plant was obtained with the biofortifying treatment (2.0, 2.5, 3.0, and 3.5 kg/ha) since it allowed means of 9.5, 11.1, 9.9, and 10.0 grams. This treatment was statistically equal to the biostrengthener (1.0 kg/ha) which showed a mean of 9.3 grams (Table 31).

TABLE 31
Comparison of means of the whole plant dry weight variable

| | | Whole plant dry | |
|---|---|---|---|
| Treatments | Dose | weight (g) | Significance |
| T1 | — | 6.8 | B |
| T2 | 1.0 kg/ha | 9.3 | AB |
| T3 | 2.0 kg/ha | 9.5 | A |
| T4 | 2.5 kg/ha | 11.1 | A |
| T5 | 3.0 kg/ha | 9.9 | A |
| T6 | 3.5 kg/ha | 10.0 | A |

7. Assimilation of Phosphorus, Potassium, and Zinc

An analysis of variance was carried out with the data of the assimilation of phosphorus, potassium, and zinc variable in tomato crop. The analysis showed significant differences between the treatments evaluated with respect to the absolute control. This was confirmed by a Tukey comparison of means (a=0.05) (Table 32). In the case of phosphorus (P) assimilation, the treatments that showed the best results were the biostrengthener (1.0, 2.0, 2.5, 3.0, and 3.5 kg/ha) since means of 0.48, 0.52, 0.63, 0.50, and 0.58% were obtained. The biostrengthener treatments (2.0, 2.5, 3.0 and 3.5 kg·ha⁻¹) showed higher assimilation of potassium (K), since means of 4.7, 5.1, 5.1, and 5.1% were obtained. Similarly, the aforementioned treatments showed higher assimilation of zinc (Zn) with means of 45.7, 44.5, 48.2, and 47.2%.

TABLE 32
Comparison of means of the assimilation of P, K, and Zn variable.

| Treatments | Dose | P (%) | K (%) | Zn (%) |
|---|---|---|---|---|
| T1 | — | 0.21 B | 3.0 C | 24.2 B |
| T2 | 1.0 kg/ha | 0.48 A | 3.8 B | 34.5 AB |
| T3 | 2.0 kg/ha | 0.52 A | 4.7 A | 45.7 A |
| T4 | 2.5 kg/ha | 0.63A | 5.1 A | 44.5A |
| T5 | 3.0 kg/ha | 0.50A | 5.1 A | 48.2 A |
| T6 | 3.5 kg/ha | 0.58A | 5.1 A | 47.2 A |

8. Chlorophyll Content in Leaves

An analysis of variance was carried out with the data of the variable content of chlorophyll in leaves in tomato crop, which did not show significant differences between the treatments evaluated with respect to the absolute control. This was confirmed by a Tukey comparison of means (a=0.05) (Table 33).

TABLE 33
Comparison of means of the content
of chlorophyll in leaves variable.

| | | Content of | |
|---|---|---|---|
| Treatments | Dose | chlorophyll (SPAD) | Significance |
| T1 | — | 40.0 | A |
| T2 | 1.0 kg/ha | 40.2 | A |
| T3 | 2.0 kg/ha | 40.8 | A |
| T4 | 2.5 kg/ha | 40.5 | A |
| T5 | 3.0 kg/ha | 39.7 | A |
| T6 | 3.5 kg/ha | 40.2 | A |

9. Stomatal Conductance

An analysis of variance was carried out with the data of the stomatal conductance variable in tomato crop, which did not show significant differences between the treatments evaluated with respect to the absolute control. This was confirmed by a Tukey comparison of means (a=0.05) (Table 34).

TABLE 34
Comparison of means of the stomatal conductance variable

| | | Stomatal | |
|---|---|---|---|
| Treatments | Dose | conductance | Significance |
| T1 | — | 0.6 | A |
| T2 | 1.0 kg/ha | 0.6 | A |
| T3 | 2.0 kg/ha | 0.7 | A |
| T4 | 2.5 kg/ha | 0.8 | A |
| T5 | 3.0 kg/ha | 0.6 | A |
| T6 | 3.5 kg/ha | 0.7 | A |

Phytotoxicity

No symptoms of phytotoxicity were shown in the tomato crop while carrying out and applicating the biostrengthener in its doses of 1.0, 2.0, 2.5, 3.0, and 3.5 kg/ha.

### Conclusions

In its doses of 2.0, 2.5, 3.0, and 3.5 kg/ha, the biostrengthener showed an increase in tomato crop variables (stem diameter, plant height, leaf number per plant, fresh and dry weight of the root, fresh and dry weight of the plant, as well as the content of chlorophyll in leaves).

1. A plant biological strengthener (biostrengthener) composition formulated as a wettable powder from vesicular arbuscular mycorrhizae and plant nutrients to improve crop yields comprising:
a biological composition as a microbial active ingredient,
active ingredients as nutrients and plant growth enhancers,
inert compounds, and
a particle size that allows optimal assimilation of crops, protection from the root of the plant and blockage by sedimentation of nozzles.

2. The composition according to claim 1, wherein the biological composition comprises a consortium of spores alone or in mixture belonging to the strains of arbuscular vesicle mycorrhizal fungi selected from the group consisting of Glomus geosporum, Gigaespora margarita, Glomus fasciculatum, Glomus constrictum, Glomus torluosum and Glomus intraradices, supplied in the formulation in a percentage of 0.1-50% (w/w) containing a concentration of 25-110 propagules/g as the microbial active ingredient.

3. The composition according to claim 1, further comprising extracts of humic and fulvic acids in a concentration of 0.1% to 25%, yucca extract (Yucca schidigera) in a concentration of 0.01% to 10%, seaweed extract (Ascophyllum nodosum) in a concentration of 0.01 to 10%, and natural rooters (2,4-D-indoleacetic acid) that ensure a concentration of 0.001% to 1%.

4. The composition according to claim 1, wherein the inert compounds are selected from the group consisting of: oligosaccharides ensuring a concentration of at least 45%, polysaccharides ensuring a concentration of at least 0.1%-3% and a silicon source ensuring a concentration of at least 0.1% to 0.5% wherein the inert compounds add up to concentration between 40 to 47%.

5. The composition according to claim 1, wherein the particle size is between 177 microns and 105 microns.

6. The composition according to claim 1, wherein the composition further comprises a pH within a range of 8.0 to 10 to guarantee a good state of the environment of the microbial rhizosphere.

7. A method for improving crop protection through biological control of the genera of phytopathogenic fungi Phytophthora sp., Rizhoctonia sp., Pythium sp., Fusarium sp., comprising applying the composition according to claim 1 to the crop.

8. The composition according to claim 4, wherein the oligosaccharides are selected from the group consisting of maltodextrin, maltose, dextrin and dextrose.

9. The composition according to claim 4, wherein the polysaccharides are selected from the group consisting of starch, glycogen, cellulose, chitin, paramylon, agarose, peptidoglycans, proteoglycans, hyaluronic acid, amylose, fructan, keratin sulfate, dermatan sulfate, xylan and amylopectin.

10. The composition according to claim 4, wherein the silicon source is selected from the group consisting of Mg₃Si₄Q₁₀(OH)₂, CaSi, H₄SiO₄, AlSi₃, CaAl₂Si₂O₈, 2NaAISi₃O₈, SiO₂ and 4H₄SiO₄.
